(19) United States
(12) Patent Application Publication
(10) Pub. No.: US 2018/0232627 A1
(43) Pub. Date: Aug. 16, 2018

(54) VARIABLE WORD LENGTH NEURAL NETWORK ACCELERATOR CIRCUIT

(71) Applicant: Intel IP Corporation, Santa Clara, CA (US)

(72) Inventors: Piotr Rozen, Gdansk (PL); Ramya Rasipuram, Sunnyvale, CA (US); Georg Stemmer, Munchen (DE)

(21) Appl. No.: 15/435,045

(22) Filed: Feb. 16, 2017

(51) Int. Cl. G06N 3/04; G06F 5/01; G05B 15/02

(52) U.S. Cl. CPC G06N 3/04; G05B 15/02; G06F 5/01

(57) ABSTRACT

A processing system includes a processor to execute a neural network application comprising an operation associated with a weight parameter and an input value, and an accelerator circuit, associated with the processor, to perform the operation, the accelerator circuit comprising a weight storage device to store a bit stream encoding the weight parameter, a controller to request a bit from the bit stream, an input data storage to store the input value, and an arithmetic logic unit (ALU) comprising an accumulator circuit to store an accumulation value and an operator circuit to receive the bit and the input value, receive a control signal from the controller, and responsive to determining that the control signal is set to a first value corresponding to a first operation and that that the bit encodes a first status, increase the accumulation value, stored in the accumulation circuit, by the input value.

### TECHNICAL FIELD

The present disclosure relates to a processing device and, more specifically, relate to a variable word length accelerator circuit that can perform calculations in neural network computing.

### BACKGROUND

An artificial neural network (referred to as “neural network”) is a computation method that simulates the process of a biological neural network to achieve computation results. Artificial neural networks are used extensively in multiple domains to provide solutions for different problems. For example, neural networks are used in speech recognition, natural language processing, visual object recognition, driver assistance systems, fraud detection systems, traffic control systems, inventory and sales prediction systems, etc.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a system-on-a-chip (SoC) that can perform efficient calculations on variable-length representation of weight parameters according to an embodiment of the present disclosure.

FIG. 2 illustrates the input data storage and the arithmetic logic unit (ALU) to perform operations according to an embodiment of the present disclosure.

FIG. 3A illustrates an example of a multiplication in a MAC operation according to an embodiment of the present disclosure.

FIG. 3B illustrates an example of a matching in an XNOR operation according to an embodiment of the present disclosure.

FIG. 4 is a block diagram of a method to perform a delegated operation on the accelerator circuit according to an embodiment of the present disclosure.

FIG. 5A is a block diagram illustrating a micro-architecture for a processor including heterogeneous core in which one embodiment of the disclosure may be used.

FIG. 5B is a block diagram illustrating an in-order pipeline and a register renaming stage, out-of-order issue/execution pipeline implemented according to at least one embodiment of the disclosure.

FIG. 6 illustrates a block diagram of the micro-architecture for a processor that includes logic in accordance with one embodiment of the disclosure.

FIG. 7 is a block diagram illustrating a system in which an embodiment of the disclosure may be used.

FIG. 8 is a block diagram of a system in which an embodiment of the disclosure may operate.

FIG. 9 is a block diagram of a system in which an embodiment of the disclosure may operate.

FIG. 10 is a block diagram of a System-on-a-Chip (SoC) in accordance with an embodiment of the present disclosure

FIG. 11 is a block diagram of an embodiment of an SoC design in accordance with the present disclosure.

FIG. 12 illustrates a block diagram of one embodiment of a computer system.

### DETAILED DESCRIPTION

The neural network computation may involve processing of millions of input values and parameters. The neural network processing typically includes several types of operations (e.g., multiply-accumulate (MAC) operations which are equivalent to an XOR operation when the data are one bit long) which can consume a large amount of computing resources (e.g., in terms of processor cycles and memory). To speed up the calculation, some of the operations associated with the neural network calculation may be carried out on special-purpose hardware circuits (referred to as accelerator circuits).

A neural network may include multiple layers of calculations. Each layer is an array of calculation functions (referred to as nodes) that are interconnected to nodes in another layer. A calculation function in one layer may receive weight parameters and input values and convert them into an output value that may be fed, as the input value, into another calculation function in another layer. Thus, the neural network may include interconnected layers of nodes, wherein each node perform the operation (e.g., MAC or XNOR) on the weight parameters and the input values to generate the output value. In some implementations, the node may further optionally apply an activation function to the calculated results calculated from the weight parameters and the input values. The activation function can be a non-linear function.

The weight parameters are typically stored in the memory coupled to a processor via a bus system. The data retrieval time for memory by the processor is commonly longer than that from cache memory. The processor executing the neural network application may load the weight parameters into registers on the accelerator circuits. The processor may further delegate execution of operations (e.g., MAC or XNOR) to the accelerator circuits to enhance the overall speed and resource usage efficiencies of the neural network calculation. For example, the accelerator circuits may include arrays of computation elements to perform the MAC operations and/or the XNOR operations, and the processor may delegate the MAC operations and/or XNOR associated with a neural network to the accelerator circuit.

In the hardware implementation of a neural network, the weight parameters and input values are stored in registers the sizes of which are typically multiples of bytes (e.g., one byte (eight bits) or two bytes (16 bits)). The number of bits used in the hardware implementation to store a parameter (either the weight or the input) is referred to as the precision of the representation. A neural network, however, can achieve satisfactory accuracy in results using low-precision representation of weight parameters. The low-precision representation of weight parameters may use fewer bits than those in a byte (8 bits). In such situations, it is not efficient to use the fixed-length representations (e.g., one byte or two bytes) to represent the weight parameters in the neural network calculation.

Instead of loading weight parameters as multiples of bytes into fixed-length registers associated with the accelerator circuit, a storage device of the accelerator circuit may supply each of the weight parameters as a sequence of bits (referred to as a bit stream) arithmetic logic units (ALUs) employed to perform operations of neural networks. An ALU is a digital circuit that can perform arithmetic and bitwise operations on its inputs. In one embodiment, each one of the ALUs may receive, at its input, a respective bit stream representing a respective weight parameter. Thus, at the initial clock cycle, each one of the ALUs may receive the first bit of these bit streams; the second bit of the bit streams may be received at the subsequent second clock cycle, and so on. Each ALU is to sequentially receive one bit from their corresponding bit stream during a clock cycle. Thus, eight bit streams each comprising five bits may encode eight weight parameters of five-bit precision. Compared to storing the eight weights in eight 8-bit registers, embodiments of the present disclosure can achieve a smaller footprint of neural network circuitry that may save energy consumption and achieve faster neural network propagation between layers.

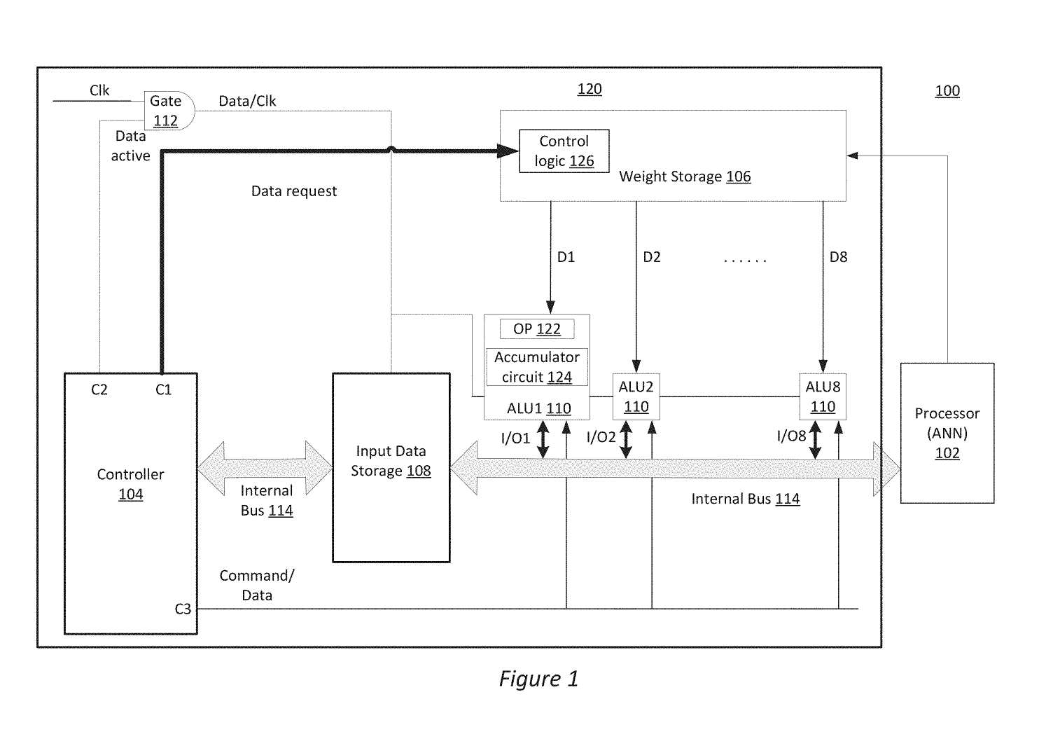

Embodiments of the present disclosure provide a hardware accelerator circuit that is capable of transferring data and control signals in a same communication channel (in-band data processing). The accelerator circuits include ALUs that perform calculation of data in pace of data transfer. FIG. 1 illustrates a system-on-a-chip (SoC) 100 that can perform efficient calculations on variable-length representation of weight parameters according to an embodiment of the present disclosure. As shown in FIG. 1, the SoC 100 may include a processor 102 and a hardware accelerator circuit 120 to perform a pre-defined set of calculations corresponding to operations in a neural network application. In one embodiment, accelerator circuit 120 is a discrete circuit connected to processor 102. In another embodiment, accelerator circuit 120 is a circuit component of processor 102.

Processor 102 may be a hardware processing device such as, for example, a central processing unit (CPU) or a graphic processing unit (GPU) that includes one or more processing cores to execute software applications. In one embodiment, processor 102 may execute a software application such as, for example, an artificial neural network (ANN) application. The ANN application may be represented using a diagram including layers of nodes interconnected with arcs. Each arc may represent a weight parameter to be applied to an input value of the node. Each node may represent a pre-defined type of calculation using the weight parameter and the input value. In one embodiment, the pre-defined calculation can be an MAC operation or an XNOR operation. For example, the MAC operation may include the weighted sum of input values achieved by accumulating the multiplications of the input values with weight parameters (i.e., O=ΣIₖ*Wₖ, where O is the output, Iₖ is the k^{th} input value and Wₖ is the k^{th} weight parameter). The ANN may also include other types of operations such as, for example, the match operation (Oₖ=Iₖ XNOR Wₖ, where XNOR is the complement of the bit-wise exclusive OR operator).

Instead of performing these operations associated with the ANN application on processor 102, embodiments of the present disclosure may provide an accelerator circuit 120 that include logic circuit components to perform these pre-defined operations. Responsive to determining a need to calculate one of the pre-defined operations on weight parameters and input values, processor 102 may provide the weight parameters and the input values to accelerator circuit 120 and delegate accelerator circuit 120 to perform the pre-define operations. Processor 102 may delegate by issuing instructions to transfer input values and weight parameters to accelerator circuit 120, initiating the calculator on the accelerator circuit 120, and retrieving the calculation results from accelerator circuit 120. Compared to the general-purpose computing circuit such as processor 102, the special-purpose accelerator circuit 120 can calculate the results of the pre-defined operations much faster and consuming less power.

In one embodiment, accelerator circuit 120 may include a controller 104, a weight storage device 106, an input data storage device 108, and a row of arithmetic logic units (ALUs) 100 that are interconnected using an internal bus system 114. Internal bus system 114 may be used to transmit data (e.g., in bytes) and/or control signals (e.g., in bit flags) among these hardware components according to a pre-defined protocol.

Controller 104 may include integrated circuits configured to transmit control signals to weight storage device 106, input data storage device 108, and ALUs 110. Controller 104 may use the control signals to set the operation modes of these devices, where the operation mode may specify which calculation (MAC or XNOR) to perform. In one embodiment, controller 104 may include three control signal outputs C1, C2, C3. The first control signal output (C1) is connected to weight storage device 106 to provide a data request signal to the device.

The second control signal output (C2) is connected to a first input node of a logic gate 112. The second control signal is a data activation signal generated by controller 104. The data activation signal can be a gate signal that, when set to high, allow data transfer to input storage device 108, and when set to low, prohibit data transfer. A second input node of logic gate 112 is connected to a clock that generates a clock signal (Clk). The clock signal may include a sequence of clock cycles, where a feature (e.g., the rising edge) of each clock cycle may serve as the trigger signals in the clock cycle. Responsive to detecting the trigger signal, ALUs 110 may execute the calculation using the input value and the bit from the bit stream. Logic gate 112 may combine the data activation signal with the clock signal to generate a data/clock control signal. For example, logic gate 112 can be an AND gate, and the data/clock control signal is high when both the clock signal and the data activation signal are high; and is low when any one of the clock signal and the data activation signal is low. The data/clock control signal is also provided to input data storage device 108 and ALUs 110 as the clock signal to enable (or disable) the operations of these devices.

The third control signal output C3 is connected to ALUs 110 to set an operation mode for the ALUs. The operation mode may determine which pre-defined operation the ALUs are to perform. The operation modes may include the MAC operation and the match operation.

Weight storage device 106 may store a set of weight parameters used in the ANN calculation. Processor 102 may execute store instructions to store the weight parameters in weight storage 106, and update these weight parameters during the execution of ANN application. In another embodiment, weight storage 106 can be a storage device external to accelerator circuit 120. Weight storage device 106 may further include control logic circuit 126 to provide the weight parameters as bit streams at output nodes D1-D8. In one embodiment, each bit stream may include a sequence of bits encoding the corresponding weight parameter. At each clock cycle, controller 104 may generate a data request signal to weight storage device 106. The data request signal causes weight storage device 106 to output, in parallel, one bit from each one of the bit streams at output nodes D1-D8. Thus, at the initial clock cycle, weight storage device 106 may output the first bits of these bit streams; at a subsequent second clock cycle, weight storage device 106 may output the second bits of these bit streams. This may continue until exhausting bits in the bit streams.

In one embodiment, each one of the bit streams may include fewer bits than the length of a fixed length register. For example, each bit stream may include five bits which is fewer than the eight bits in a byte word. Thus, the bit streams encode a low-precision representation of weight parameters using a smaller circuit area than registers that store byte words.

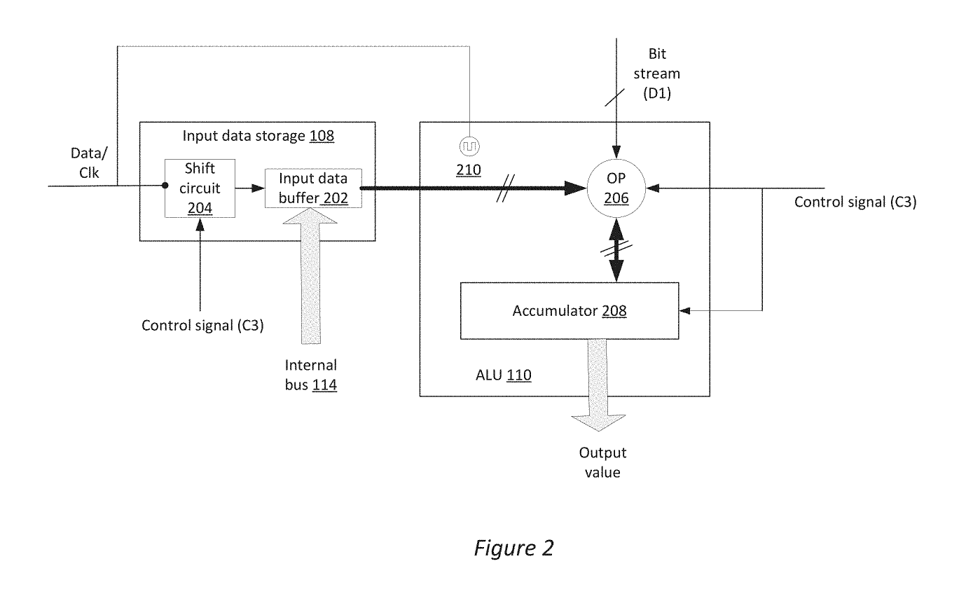

Input data storage 108 may store the input value used in the calculation operations (e.g., MAC or XNOR). Although input data storage 108 is shown in accelerator circuit 120, in another embodiment, input data storage 108 can be an external storage device coupled to accelerator circuit 120 via a bus system. Responsive to each clock cycle (when data signal (from C2) is high), the data/clock control signal may expose the input value on internal bus 114. Input data storage 108 can also store shifted version of the input value as discussed in conjunction of FIG. 2 describing ALUs 110. Further, the data/clock control signal may drive ALUs 110 to use the current bit in bit streams D1-D8. Each ALU 110 may include an operator circuit 122 and an accumulator circuit 124. Operator circuit 122 may receive the bit stream (D1, D2, . . . or D8) and the input value, and further perform a calculation. Accumulation circuit 124 may store calculation results including the intermediate results during processing each bit in the bit streams and the final results after processing all bits in the bit streams. The final results of the calculation operation may achieve after controller 104 generates enough data requests that cycle through all the bits in the bit stream encoding the weight parameters.

FIG. 2 illustrates the input data storage 108 and the arithmetic logic unit (ALU) 110 to perform operations according to an embodiment of the present disclosure. Referring to FIG. 2, input data storage 108 may include an input data buffer 202 and a shift circuit 204. Input data buffer 202 may store an input value received from internal bus 114. In one embodiment, the input value can be represented with a word the size of which is a multiple of bytes (e.g., two bytes). Shift circuit 204 may receive a trigger signal in a clock cycle and may cause the input value stored in input data buffer to shift one bit position (either to right or to left based on a set shift-direction mode). The control signal (from C3) may set the shift-direction mode of shift circuit 204. In one embodiment, the control signal corresponding to the MAC operator may set the shift-direction mode as shifting one bit position to the left. Alternatively, the control signal corresponding to the XNOR operator may set the shift-direction mode as shifting one bit position to the right.

ALU 110 may include an operator circuit 206 and an accumulator circuit 208. Operator circuit 206 may be coupled to input data buffer 202 to receive the input value (or a shifted version of the input value). Operator circuit 206 may also be coupled to a bit stream (e.g., D1) to receive a bit in the bit stream. The accumulator circuit 208 may include logics to store an accumulated value. Further, operator circuit 206 may be coupled to accumulator circuit 208 to receive the accumulated value. Operator circuit 206 may receive the value stored in accumulator circuit 208, and perform a calculation based on the bit received from the bit stream under the mode (MAC or XNOR) set by the control signal (from C3), where the calculation is related to performing the operations (e.g., MAC or XNOR) requested by processor 102.

ALU 110 may further include a calculation advance circuit 210 to receive the data/clock signal. Responsive to detecting a trigger in the data/clock signal (e.g., detecting a rising edge in the data/clock waveform), calculation advance circuit 210 may cause ALU 110 to complete the calculation with respect to one bit from the bit stream, and advance the calculation to a next bit in the bit stream within one cycle of the data/clock waveform, where the data/clock waveform is a periodic waveform.

In one embodiment, the control signal (from C3) may set operator circuit 206 to the first mode corresponding to the MAC operation. Under the MAC mode, in a clock cycle, operator circuit 206 may receive the input value from input data buffer 202, an accumulation value from accumulator circuit 208, and a bit value from the bit stream (e.g., D1). Responsive to determining that the bit value indicates a first status of accumulation (e.g., set to “1”), operator circuit 206 is to increase the accumulation value stored in accumulator circuit 208 by the amount of the input value. Responsive to determining that the bit value indicates a second status of accumulation (e.g., set to “0”), operator circuit 206 is to maintain the accumulation value stored in accumulator circuit 208. In one embodiment, ALU 110 may include clock gating logic circuit. Responsive to receiving the “0” value in the bit stream, the clock gating logic circuit may remove the enabling condition to ALU 110 to achieve the maintenance of the accumulation value stored in accumulation circuit 208. By using the clock gating logic circuit, the design of ALU 110 may eliminate the need for some of multiplexers in ALU 110, thus reducing the energy consumption and the area of ALU 110. At a subsequent second clock cycle, the control signal may trigger shift circuit 204 to shift the input value stored in input data buffer 202 to the left by one bit position. The control signal may also cause the bit stream to move to the second bit in the bit stream. Then, operator circuit 206 may perform the same calculations using the second bit, the input value stored in the input data buffer 206, and the accumulation value stored in the accumulator circuit 208. These calculations are repeated in each subsequent clock cycle until the bits in the bit stream are all used in the calculation. Then, the accumulation value stored in the accumulator circuit 208 is the product of the weight parameter encoded in the bit stream and the input value. In one embodiment, the control signal (C3) may include the third mode (referred to the data mode). The data mode may trigger the output of the value stored in the accumulator circuit 208, via the internal bus 114, to processor 102.

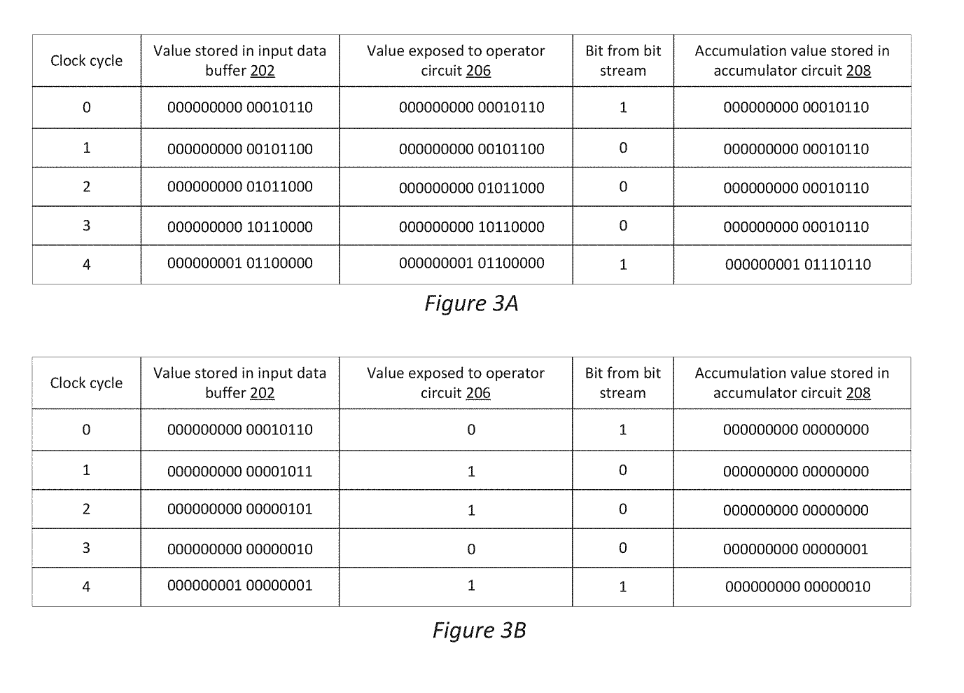

FIG. 3A illustrates an example of a multiplication in a MAC operation according to an embodiment of the present disclosure. For the clarity of description, components as labeled in FIG. 2 are used to describe the example. At initial before clock cycle 0, accumulation value stored in accumulator circuit 208 may be set to all zeros. As shown in FIG. 3A, at clock cycle 0, responsive to determining that the weight bit is set to “1,” operator circuit 206 is to add the input value “00000000 00010110” to accumulator circuit 208 so that the accumulation value stored in accumulator circuit is “00000000 00010110”. At clock cycle 1, the input value stored in input data buffer 202 is shifted one bit position to the left. The input data buffer 202 is to store the shifted version of the input value which is “00000000 000101100”. Responsive to determining that the weight bit is set to “0,” operator circuit 206 is to maintain the accumulation value (“00000000 00010110”) in accumulator circuit 208. The process to shift the input data buffer 202 and to add/maintain the value stored in accumulator circuit 208 is repeated for each clock cycle (0-4) until the last bit in the bit stream. The resulting accumulation value (“00000001 01110110”) stored in accumulator circuit 208 is the product of the original input value (“00000000 00010110”) and the weight parameter (“10001”). The multiplication is accomplished in-band with data transfer from the bit stream and without storing the weight parameter in an 8-bit register.

In another embodiment, the control signal (from C3) may set operator circuit 206 to the second mode corresponding to the XNOR operation. Under the XNOR mode, the shift circuit 204 may shift value stored in the input data buffer 202 by one bit position to the right. In an initial clock cycle, operator circuit 206 may receive the rightmost bit from input data buffer 202, and a bit value from the bit stream (e.g., D1). Operator circuit 206 may compare the rightmost bit received from input data buffer 202 and the bit from the bit stream. Responsive to determining that the bit value from input data buffer 202 is different from the bit value from the bit stream, operator circuit 206 may maintain the accumulation value stored in accumulator circuit 206. Responsive to determining that the bit value from input data buffer 202 is the same as the bit value from the bit stream, operator circuit 206 may increase the accumulation value stored in accumulator circuit 206 by one. In the subsequent second clock cycle after the initial clock cycle, shift circuit 204 may shift the value stored in input data buffer 202 by one bit position to the right. Operator circuit 206 may receive the rightmost bit again from input data buffer 202 and a second bit from bit stream. Operator circuit 206 may further compare these two bits to determine whether they are the same. Operator circuit 206 may cause to increase or maintain the accumulation value dependent upon the comparison result as described above. This process is repeated until all the bits in the bit stream are processed. The result value stored in accumulator circuit 208 is a count of the number of matched bits in the input value and the weight parameter.

FIG. 3B illustrates an example of a matching in an XNOR operation according to an embodiment of the present disclosure. At initial, the accumulation value stored in accumulator circuit 208 may be set to all zeros before clock cycle 0. As shown in FIG. 3B, at clock cycle 0, responsive to determining that the weight bit (“1”) is different from the rightmost bit (“0”) in the input data buffer 202, operator circuit 206 may maintain the accumulation value (“00000000 00000000”) stored in accumulator circuit 208. At clock cycle 1, shift circuit 204 may shift the value stored in input data buffer 202 by one bit position to the right so that the rightmost bit is “1.” Further, the bit stream also moves down one bit to a second bit of “0.” Operator circuit 206 may compare and determine that these two bits are different and thus maintain the accumulation value stored in accumulator circuit. Similarly, at clock cycle 2, the operator circuit 206 is to maintain the accumulation value stored on accumulator circuit 208. At clock cycle 3, the operator circuit 206 may determine that the weight bit value (“0”) is the same as the rightmost bit value (“0”) in input data buffer 202. Responsive to the determination, operator circuit 206 may cause the accumulation value stored in accumulator circuit 208 to increase by one. Similarly, at clock cycle 4, responsive to determining that the weight bit value (“1”) is the same as the rightmost bit value (“1”) in input data buffer 202, operator circuit 206 may cause the accumulation value stored in accumulator circuit 208 to increase by one. The resulting of “00000000 00000010” is the number of matched bits between the bit stream encoding the weight parameter and the input value.

Referring again to FIG. 1, accelerator circuit 120 may include a row of multiple (e.g., ALU1 through ALU8) ALUs to perform the operations as discussed in conjunction with FIG. 2. In an ANN (e.g., a fully-connected ANN where each node of a layer is connected to each node of an adjacent layer), each node of the ANN may be connected to multiple arcs representing multiple weight parameters to be applied to an input value. Accelerator circuit 120 may include multiple ALUs to calculate the products between these weight parameters and the input value.

In one embodiment, accelerator circuit 120 may further include multiple input data storages, multiple internal buses, and multiple rows of ALUs, where each input data storage is to store one input value. Each internal bus is to connect one input data storage to one row of ALUs to perform the calculation for one node. Thus, processor 102 may delegate certain operation calculation associated with multiple nodes in parallel.

Processor 102 may control the provision of the input values and weight parameters to accelerator circuit 120 and set up controller 104. In one embodiment, responsive to determining that a set of nodes in the ANN calculation can be delegated to accelerator circuit 120, processor 102 may issue instructions to transfer input values from a memory to input data storage 108 and instructions to transfer weight parameters from the memory to weight storage 106. Processor 102 may also issue instructions to controller 104, where the instructions may include the operation mode for ALUs 110, the number of bits (referred to as the bit depth) in the bit streams, the number of input values, and the number of bit streams). Processor 102 may also issue instructions to reset the accumulator circuits in ALUs 110, and issue the start instruction to controller to initiate the calculation by accelerator circuit 120.

At the conclusion of the calculation (e.g., after N clock cycles, where N is the bit depth of the bit streams), processor 102 may retrieve the values stored in accumulator circuits and apply the activation functions to these values. In parallel, processor 102 may issue instructions to accelerator circuit 120 to perform the calculations for these nodes with updated input values from a previous layer of nodes.

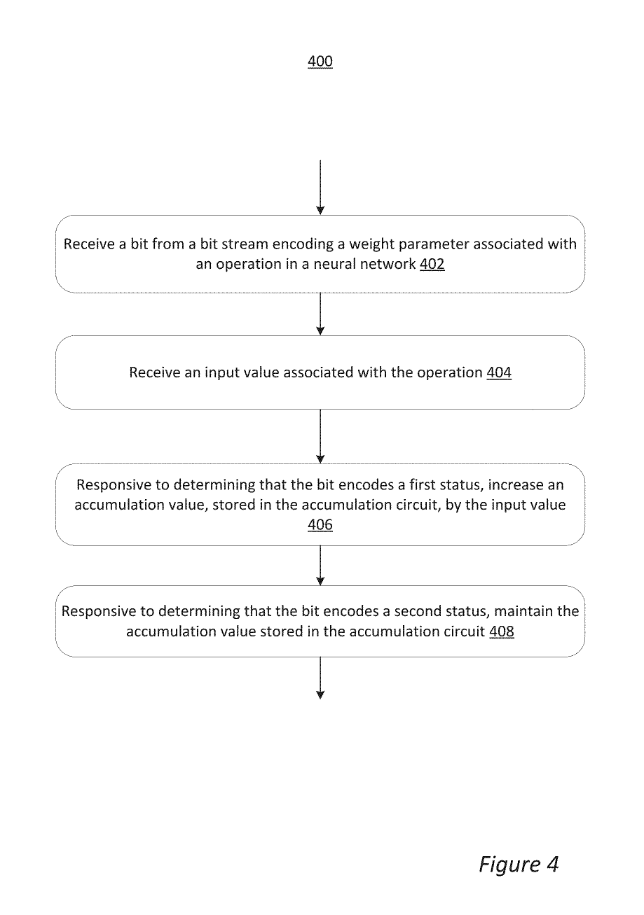

FIG. 4 is a block diagram of a method 400 to perform a delegated operation on the accelerator circuit according to an embodiment of the present disclosure. Method 400 may be performed by processing logic that may include hardware (e.g., circuitry, dedicated logic, programmable logic, microcode, etc.), software (such as instructions run on a processing device, a general purpose computer system, or a dedicated machine), firmware, or a combination thereof. In one embodiment, method 400 may be performed, in part, by operator circuit 120 and operator circuit 206 shown in FIG. 1.

For simplicity of explanation, the method 400 is depicted and described as a series of acts. However, acts in accordance with this disclosure can occur in various orders and/or concurrently and with other acts not presented and described herein. Furthermore, not all illustrated acts may be performed to implement the method 400 in accordance with the disclosed subject matter. In addition, those skilled in the art will understand and appreciate that the method 400 could alternatively be represented as a series of interrelated states via a state diagram or events.

Referring to FIG. 4, at 402, accelerator circuit 120 may receive a bit from a bit stream encoding a weight parameter associated with an operation in a neural network. The operation can be associated with the MAC or XNOR operation.

At 404, accelerator circuit 120 may receive an input value associated with the operation.

At 406, responsive to determining that the bit encodes a first status, accelerator circuit 120 may increase an accumulation value, stored in the accumulation circuit, by the input value.

At 408, responsive to determining that the bit encodes a second status, accelerator circuit 120 may maintain the accumulation value stored in the accumulation circuit.

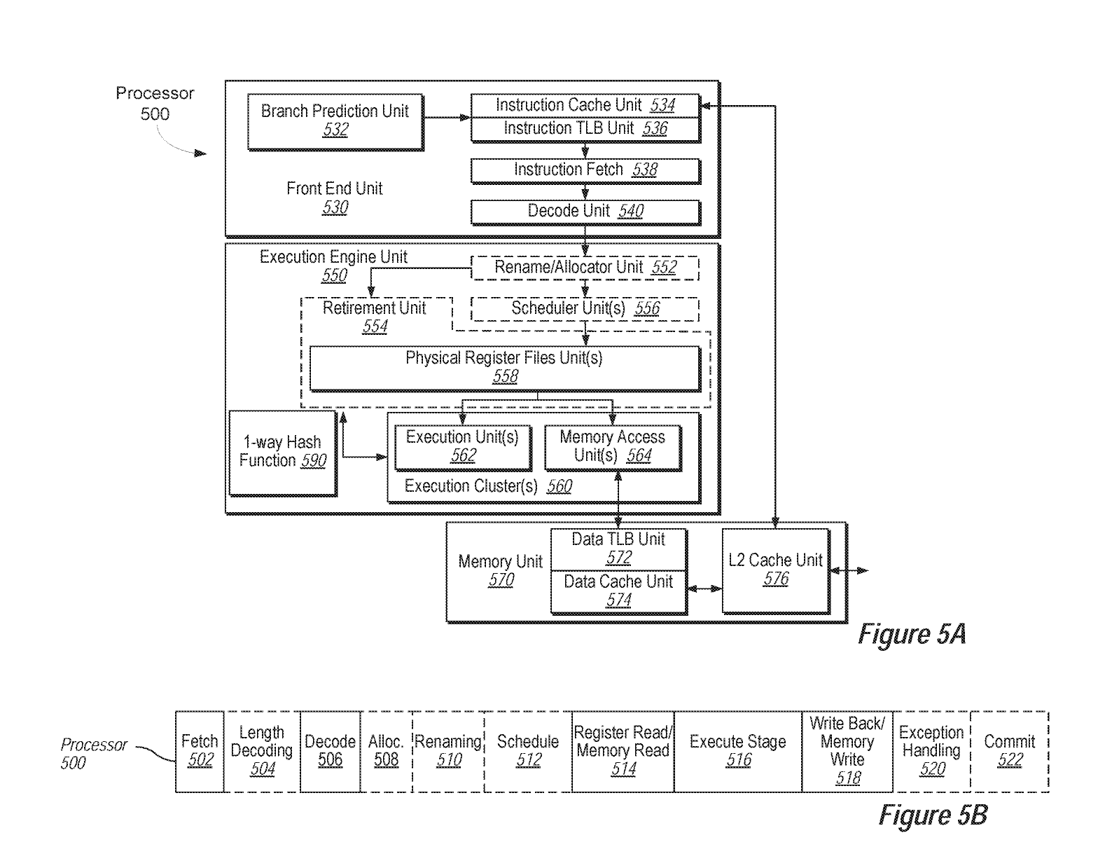

FIG. 5A is a block diagram illustrating a micro-architecture for a processor 500 that implements the processing device including heterogeneous cores in accordance with one embodiment of the disclosure. Specifically, processor 500 depicts an in-order architecture core and a register renaming logic, out-of-order issue/execution logic to be included in a processor according to at least one embodiment of the disclosure.

Processor 500 includes a front end unit 530 coupled to an execution engine unit 550, and both are coupled to a memory unit 570. The processor 500 may include a reduced instruction set computing (RISC) core, a complex instruction set computing (CISC) core, a very long instruction word (VLIW) core, or a hybrid or alternative core type. As yet another option, processor 500 may include a special-purpose core, such as, for example, a network or communication core, compression engine, graphics core, or the like. In one embodiment, processor 500 may be a multi-core processor or may part of a multi-processor system.

The front end unit 530 includes a branch prediction unit 532 coupled to an instruction cache unit 534, which is coupled to an instruction translation lookaside buffer (TLB) 536, which is coupled to an instruction fetch unit 538, which is coupled to a decode unit 540. The decode unit 540 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 540 may be implemented using various different mechanisms. Examples of suitable mechanisms include, but are not limited to, look-up tables, hardware implementations, programmable logic arrays (PLAs), microcode read only memories (ROMs), etc. The instruction cache unit 534 is further coupled to the memory unit 570. The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations (RS), central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 558 is overlapped by the retirement unit 554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

In one implementation, processor 500 may be the same as processor 102 described with respect to FIG. 1.

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which may include a data prefetcher 580, a data TLB unit 572, a data cache unit (DCU) 574, and a level 2 (L2) cache unit 576, to name a few examples. In some embodiments DCU 574 is also known as a first level data cache (L cache). The DCU 574 may handle multiple outstanding cache misses and continue to service incoming stores and loads. It also supports maintaining cache coherency. The data TLB unit 572 is a cache used to improve virtual address translation speed by mapping virtual and physical address spaces. In one exemplary embodiment, the memory access units 564 may include a load unit, a store address unit, and a store data unit, each of which is coupled to the data TLB unit 572 in the memory unit 570. The L2 cache unit 576 may be coupled to one or more other levels of cache and eventually to a main memory.

In one embodiment, the data prefetcher 580 speculatively loads/prefetches data to the DCU 574 by automatically predicting which data a program is about to consume. Prefeteching may refer to transferring data stored in one memory location of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 500 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L) internal cache, or multiple levels of internal cache. In some embodiments, the system may include a combination of an internal cache and an external cache that is external to the core and/or the processor. Alternatively, all of the cache may be external to the core and/or the processor.

FIG. 5B is a block diagram illustrating an in-order pipeline and a register renaming stage, out-of-order issue/execution pipeline implemented by processing device 500 of FIG. 5A according to some embodiments of the disclosure. The solid lined boxes in FIG. 5B illustrate an in-order pipeline, while the dashed lined boxes illustrates a register renaming, out-of-order issue/execution pipeline. In FIG. 5B, a processor pipeline 500 includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524. In some embodiments, the ordering of stages 502-524 may be different than illustrated and are not limited to the specific ordering shown in FIG. 5B.

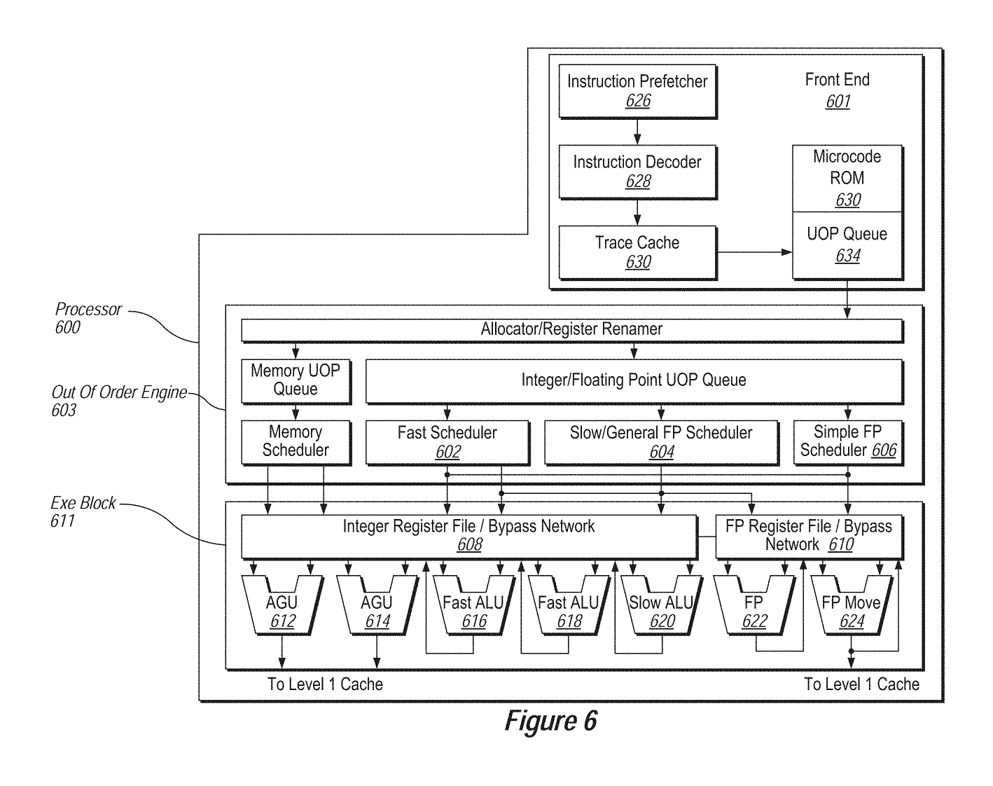

FIG. 6 illustrates a block diagram of the micro-architecture for a processor 600 that includes hybrid cores in accordance with one embodiment of the disclosure. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 601 is the part of the processor 600 that fetches instructions to be executed and prepares them to be used later in the processor pipeline.

The front end 601 may include several units. In one embodiment, the instruction prefetcher 626 fetches instructions from memory and feeds them to an instruction decoder 628 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one embodiment, if more than four micro-ops are needed to complete an instruction, the decoder 628 accesses the microcode ROM 632 to do the instruction. For one embodiment, an instruction can be decoded into a small number of micro ops for processing at the instruction decoder 628. In another embodiment, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one embodiment from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one embodiment can schedule on each half of the main clock cycle while the other schedulers can only schedule once per main processor clock cycle. The schedulers arbitrate for the dispatch ports to schedule uops for execution.

Register files 608, 610, sit between the schedulers 602, 604, 606, and the execution units 612, 614, 616, 618, 620, 622, 624 in the execution block 611. There is a separate register file 608, 610, for integer and floating point operations, respectively. Each register file 608, 610, of one embodiment also includes a bypass network that can bypass or forward just completed results that have not yet been written into the register file to new dependent uops. The integer register file 608 and the floating point register file 610 are also capable of communicating data with the other. For one embodiment, the integer register file 608 is split into two separate register files, one register file for the low order 32 bits of data and a second register file for the high order 32 bits of data. The floating point register file 610 of one embodiment has 128 bit wide entries because floating point instructions typically have operands from 64 to 128 bits in width.

The execution block 611 contains the execution units 612, 614, 616, 618, 620, 622, 624, where the instructions are actually executed. This section includes the register files 608, 610, that store the integer and floating point data operand values that the micro-instructions need to execute. The processor 600 of one embodiment is comprised of a number of execution units: address generation unit (AGU) 612, AGU 614, fast ALU 616, fast ALU 618, slow ALU 620, floating point ALU 622, floating point move unit 624. For one embodiment, the floating point execution blocks 622, 624, execute floating point, MMX, SIMD, and SSE, or other operations. The floating point ALU 622 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 616, 618. The fast ALUs 616, 618, of one embodiment can execute fast operations with an effective latency of half a clock cycle. For one embodiment, most complex integer operations go to the slow ALU 620 as the slow ALU 620 includes integer execution hardware for long latency type of operations, such as a multiplier, shifts, flag logic, and branch processing. Memory load/store operations are executed by the AGUs 612, 614. For one embodiment, the integer ALUs 616, 618, 620, are described in the context of performing integer operations on 64 bit data operands. In alternative embodiments, the ALUs 616, 618, 620, can be implemented to support a variety of data bits including 16, 32, 128, 256, etc. Similarly, the floating point units 622, 624, can be implemented to support a range of operands having bits of various widths. For one embodiment, the floating point units 622, 624, can operate on 128 bits wide packed data operands in conjunction with SIMD and multimedia instructions.

In one embodiment, the uops schedulers 602, 604, 606, dispatch dependent operations before the parent load has finished executing. As uops are speculatively scheduled and executed in processor 600, the processor 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The processor 600 also includes logic to implement store address prediction for memory disambiguation according to embodiments of the disclosure. In one embodiment, the execution block 611 of processor 600 may include a store address predictor (not shown) for implementing store address prediction for memory disambiguation.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions below, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

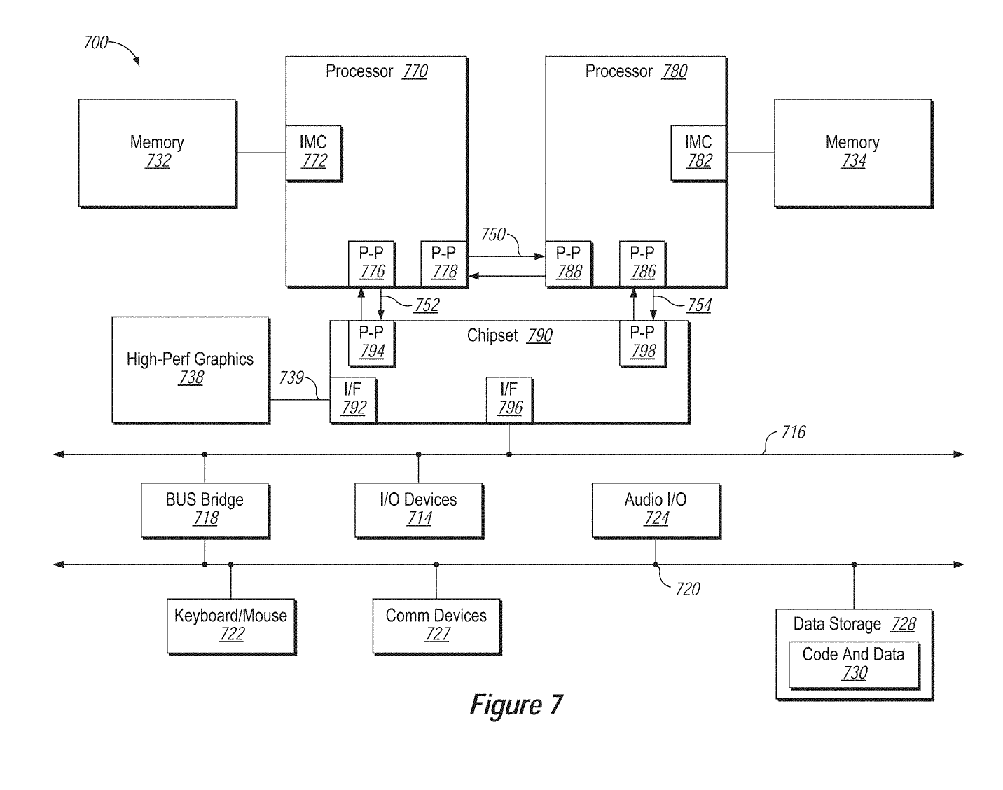

Referring now to FIG. 7, shown is a block diagram illustrating a system 700 in which an embodiment of the disclosure may be used. As shown in FIG. 7, multiprocessor system 700 is a point-to-point interconnect system, and includes a first processor 770 and a second processor 780 coupled via a point-to-point interconnect 750. While shown with only two processors 770, 780, it is to be understood that the scope of embodiments of the disclosure is not so limited. In other embodiments, one or more additional processors may be present in a given processor. In one embodiment, the multiprocessor system 700 may implement hybrid cores as described herein.

Processors 770 and 780 are shown including integrated memory controller units 772 and 782, respectively. Processor 770 also includes as part of its bus controller units point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

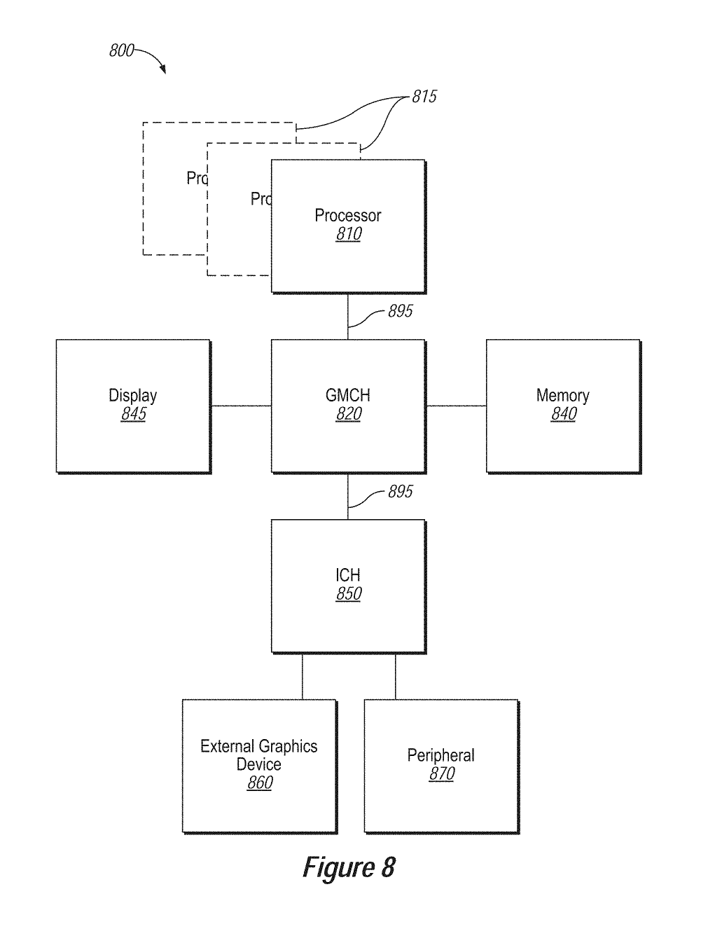

Referring now to FIG. 8, shown is a block diagram of a system 800 in which one embodiment of the disclosure may operate. The system 800 may include one or more processors 810, 815, which are coupled to graphics memory controller hub (GMCH) 820. The optional nature of additional processors 815 is denoted in FIG. 8 with broken lines. In one embodiment, processors 810, 815 implement hybrid cores according to embodiments of the disclosure.

Each processor 810, 815 may be some version of the circuit, integrated circuit, processor, and/or silicon integrated circuit as described above. However, it should be noted that it is unlikely that integrated graphics logic and integrated memory control units would exist in the processors 810, 815. FIG. 8 illustrates that the GMCH 820 may be coupled to a memory 840 that may be, for example, a dynamic random access memory (DRAM). The DRAM may, for at least one embodiment, be associated with a non-volatile cache.

The GMCH 820 may be a chipset, or a portion of a chipset. The GMCH 820 may communicate with the processor(s) 810, 815 and control interaction between the processor(s) 810, 815 and memory 840. The GMCH 820 may also act as an accelerated bus interface between the processor(s) 810, 815 and other elements of the system 800. For at least one embodiment, the GMCH 820 communicates with the processor(s) 810, 815 via a multi-drop bus, such as a frontside bus (FSB) 895.

Furthermore, GMCH 820 is coupled to a display 845 (such as a flat panel or touchscreen display). GMCH 820 may include an integrated graphics accelerator. GMCH 820 is further coupled to an input/output (I/O) controller hub (ICH) 850, which may be used to couple various peripheral devices to system 800. Shown for example in the embodiment of FIG. 8 is an external graphics device 860, which may be a discrete graphics device, coupled to ICH 850, along with another peripheral device 870.

Alternatively, additional or different processors may also be present in the system 800. For example, additional processor(s) 815 may include additional processors(s) that are the same as processor 810, additional processor(s) that are heterogeneous or asymmetric to processor 810, accelerators (such as, e.g., graphics accelerators or digital signal processing (DSP) units), field programmable gate arrays, or any other processor. There can be a variety of differences between the processor(s) 810, 815 in terms of a spectrum of metrics of merit including architectural, micro-architectural, thermal, power consumption characteristics, and the like. These differences may effectively manifest themselves as asymmetry and heterogeneity amongst the processors 810, 815. For at least one embodiment, the various processors 810, 815 may reside in the same die package.

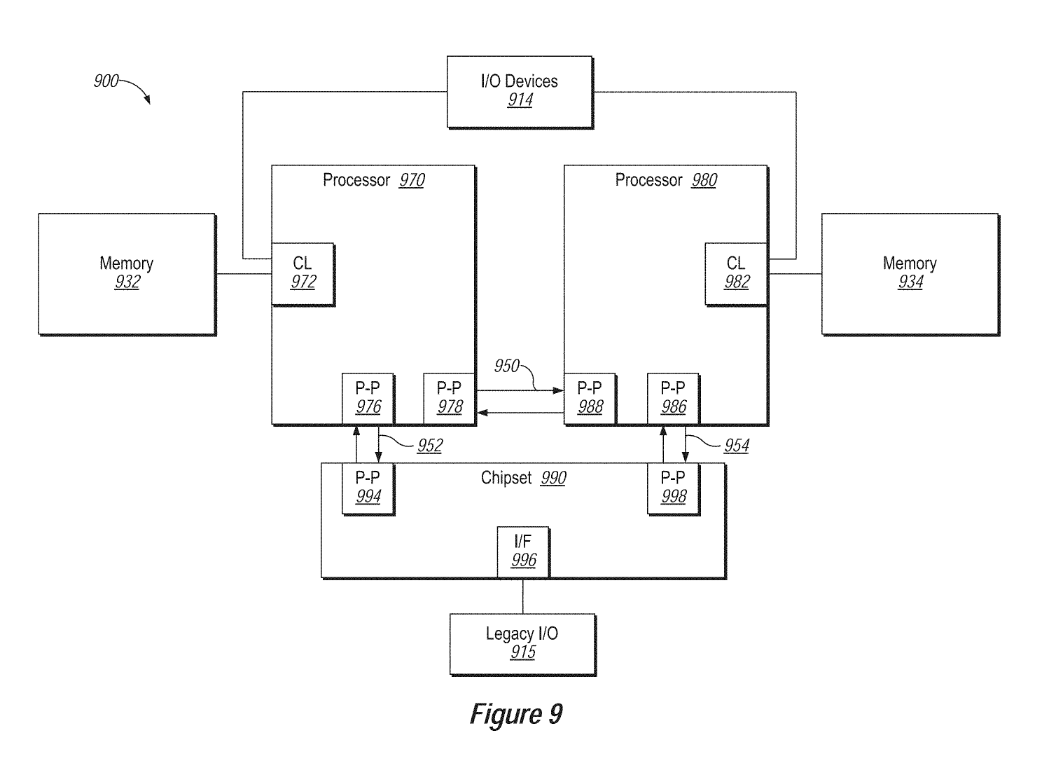

Referring now to FIG. 9, shown is a block diagram of a system 900 in which an embodiment of the disclosure may operate. FIG. 9 illustrates processors 970, 980. In one embodiment, processors 970, 980 may implement hybrid cores as described above. Processors 970, 980 may include integrated memory and I/O control logic (“CL”) 972 and 982, respectively and intercommunicate with each other via point-to-point interconnect 950 between point-to-point (P-P) interfaces 978 and 988 respectively. Processors 970, 980 each communicate with chipset 990 via point-to-point interconnects 952 and 954 through the respective P-P interfaces 976 to 994 and 986 to 998 as shown. For at least one embodiment, the CL 972, 982 may include integrated memory controller units. CLs 972, 982 may include I/O control logic. As depicted, memories 932, 934 coupled to CLs 972, 982 and I/O devices 914 are also coupled to the control logic 972, 982. Legacy I/O devices 915 are coupled to the chipset 990 via interface 996.

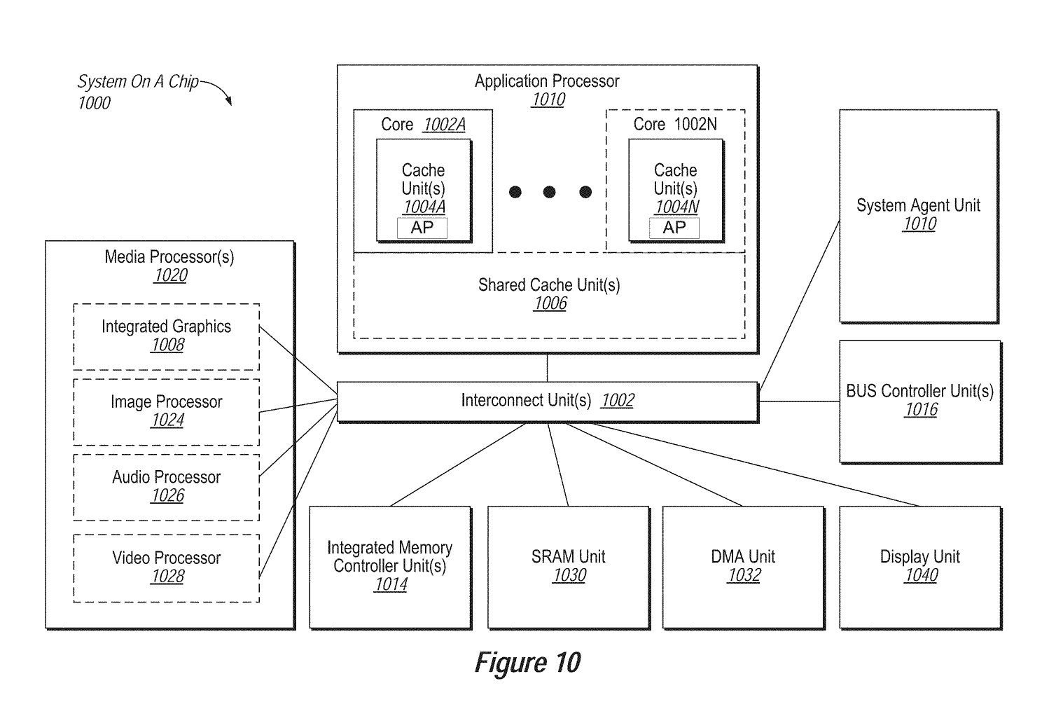

Embodiments may be implemented in many different system types. FIG. 10 is a block diagram of a SoC 1000 in accordance with an embodiment of the present disclosure. Dashed lined boxes are optional features on more advanced SoCs. In FIG. 10, an interconnect unit(s) 1012 is coupled to: an application processor 1020 which includes a set of one or more cores 1002A-N and shared cache unit(s) 1006; a system agent unit 1010; a bus controller unit(s) 1016; an integrated memory controller unit(s) 1014; a set or one or more media processors 1018 which may include integrated graphics logic 1008, an image processor 1024 for providing still and/or video camera functionality, an audio processor 1026 for providing hardware audio acceleration, and a video processor 1028 for providing video encode/decode acceleration; an static random access memory (SRAM) unit 1030; a direct memory access (DMA) unit 1032; and a display unit 1040 for coupling to one or more external displays. In one embodiment, a memory module may be included in the integrated memory controller unit(s) 1014. In another embodiment, the memory module may be included in one or more other components of the SoC 1000 that may be used to access and/or control a memory. The application processor 1020 may include a store address predictor for implementing hybrid cores as described in embodiments herein.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture and/or instruction set. For example, some of the cores 1002A-N may be in order while others are out-of-order. As another example, two or more of the cores 1002A-N may be capable of execution the same instruction set, while others may be capable of executing only a subset of that instruction set or a different instruction set.

The application processor 1020 may be a general-purpose processor, such as a Core™ i3, i5, i7, 2 Duo and Quad, Xeon™, Itanium™, Atom™ or Quark™ processor, which are available from Intel™ Corporation, of Santa Clara, Calif. Alternatively, the application processor 1020 may be from another company, such as ARM Holdings™, Ltd, MIPS™, etc. The application processor 1020 may be a special-purpose processor, such as, for example, a network or communication processor, compression engine, graphics processor, co-processor, embedded processor, or the like. The application processor 1020 may be implemented on one or more chips. The application processor 1020 may be a part of and/or may be implemented on one or more substrates using any of a number of process technologies, such as, for example, BiCMOS, CMOS, or NMOS.

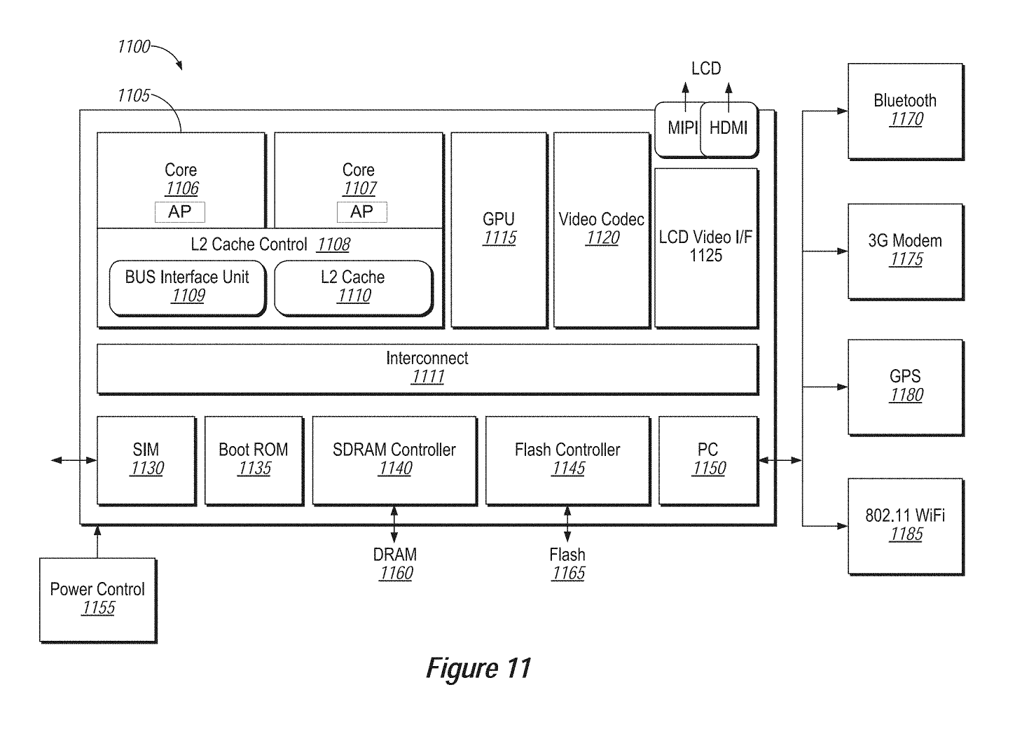

FIG. 11 is a block diagram of an embodiment of a system on-chip (SoC) design in accordance with the present disclosure. As a specific illustrative example, SoC 1100 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1100 includes 2 cores—1106 and 1107. Cores 1106 and 1107 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1106 and 1107 are coupled to cache control 1108 that is associated with bus interface unit 1109 and L2 cache 1110 to communicate with other parts of system 1100. Interconnect 1110 includes an on-chip interconnect, such as an IOSF, AMBA, or other interconnect discussed above, which potentially implements one or more aspects of the described disclosure. In one embodiment, cores 1106, 1107 may implement hybrid cores as described in embodiments herein.

Interconnect 1110 provides communication channels to the other components, such as a Subscriber Identity Module (SIM) 1130 to interface with a SIM card, a boot ROM 1135 to hold boot code for execution by cores 1106 and 1107 to initialize and boot SoC 1100, a SDRAM controller 1140 to interface with external memory (e.g. DRAM 1160), a flash controller 1145 to interface with non-volatile memory (e.g. Flash 1165), a peripheral control 1150 (e.g. Serial Peripheral Interface) to interface with peripherals, video codecs 1120 and Video interface 1125 to display and receive input (e.g. touch enabled input), GPU 1115 to perform graphics related computations, etc. Any of these interfaces may incorporate aspects of the disclosure described herein. In addition, the system 1100 illustrates peripherals for communication, such as a Bluetooth module 1170, 3G modem 1175, GPS 1180, and Wi-Fi 1185.

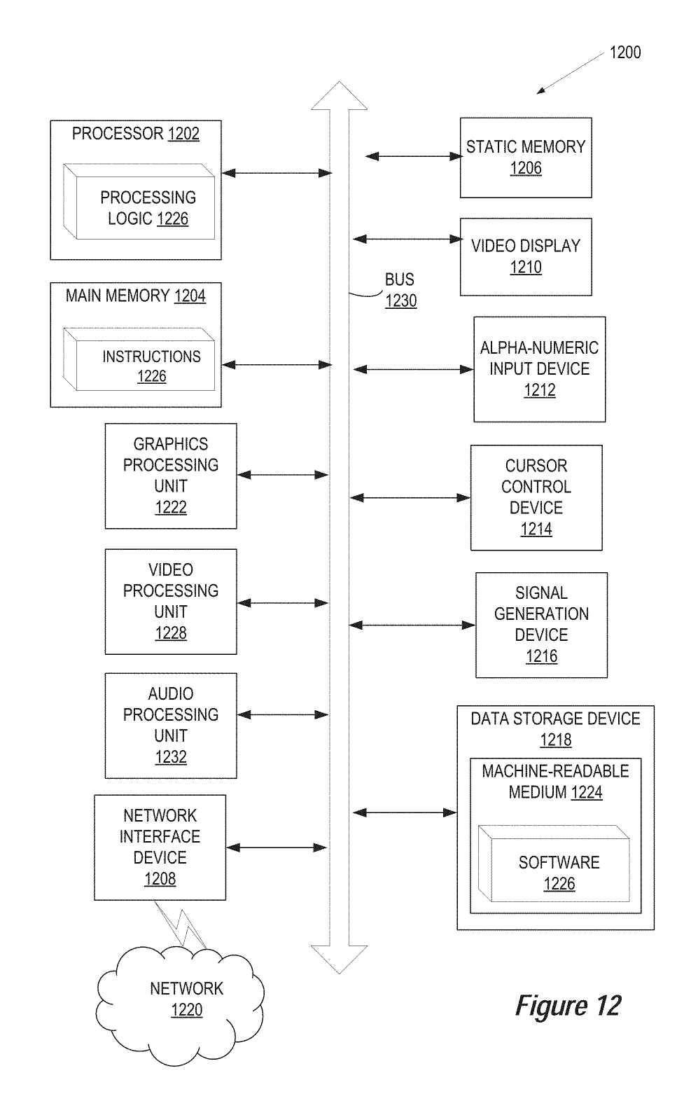

FIG. 12 illustrates a diagrammatic representation of a machine in the example form of a computer system 1200 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1200 includes a processing device 1202, a main memory 1204 (e.g., read-only memory (ROM), flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1218, which communicate with each other via a bus 1230.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. In one embodiment, processing device 1202 may include one or processing cores. The processing device 1202 is configured to execute the processing logic 1226 for performing the operations and steps discussed herein. In one embodiment, processing device 1202 is the same as processor architecture 100 described with respect to FIG. 1 as described herein with embodiments of the disclosure.

The computer system 1200 may further include a network interface device 1208 communicably coupled to a network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker). Furthermore, computer system 1200 may include a graphics processing unit 1222, a video processing unit 1228, and an audio processing unit 1232.

The data storage device 1218 may include a machine-accessible storage medium 1224 on which is stored software 1226 implementing any one or more of the methodologies of functions described herein, such as implementing store address prediction for memory disambiguation as described above. The software 1226 may also reside, completely or at least partially, within the main memory 1204 as instructions 1226 and/or within the processing device 1202 as processing logic 1226 during execution thereof by the computer system 1200; the main memory 1204 and the processing device 1202 also constituting machine-accessible storage media.

The machine-readable storage medium 1224 may also be used to store instructions 1226 implementing store address prediction for hybrid cores such as described according to embodiments of the disclosure. While the machine-accessible storage medium 1128 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present disclosure. The term “machine-accessible storage medium” shall accordingly be taken to include, but not be limited to, solid-state memories, and optical and magnetic media.

The following examples pertain to further embodiments. Example 1 is a processing system including a processor to execute a neural network application comprising an operation associated with a weight parameter and an input value, and an accelerator circuit, associated with the processor, to perform the operation, the accelerator circuit comprising a weight storage device to store a bit stream encoding the weight parameter, a controller to request a bit from the bit stream, an input data storage to store the input value, and an arithmetic logic unit (ALU) comprising an accumulator circuit to store an accumulation value and an operator circuit to receive the bit and the input value, receive a control signal from the controller, and responsive to determining that the control signal is set to a first value corresponding to a first operation and that that the bit encodes a first status, increase the accumulation value, stored in the accumulation circuit, by the input value.

In Example 2, the subject matter of Example 1 can further provide that the operator circuit is further to responsive to determining that the control signal is set to the first value and that the bit encodes a second status, maintain the accumulation value stored in the accumulation circuit.

In Example 3, the subject matter of any of Examples 1 and 2 can further provide that the input data storage comprises an input data buffer to store the input value and a shift circuit to shift, by at least one bit position, the input value stored in the input data buffer.

In Example 4, the subject matter of Example 1 can further provide that responsive to determining that the control signal is set to a second value corresponding to a second operation, the operator circuit is to compare the bit from the bit stream with a rightmost bit in the input buffer, responsive to determining that the bit from the bit stream does not match the rightmost bit, maintain the accumulation value stored in the accumulator circuit, and responsive to determining that the bit from the bit stream matches the rightmost bit, increase the accumulation value stored in the accumulation circuit by one.

In Example 5, the subject matter of any of Examples 1 and 2 can further provide that the controller is to request a second bit from the bit stream, wherein the operator circuit is to determine the accumulation value stored in the accumulator circuit based on the second bit and the input value from the input data storage.

In Example 6, the subject matter of any of Examples 1 and 2 can further provide that responsive to determining the accumulation value using a last bit in the bit stream, the processor is to retrieve the accumulation value stored in the accumulation circuit.

In Example 7, the subject matter of Example 1 can further provide that the neural network application comprises a plurality of nodes, wherein each node is to represent a calculation using the input value and the plurality of weight parameters.

In Example 8, the subject matter of any of Examples 1 and 7 can further provide that the accelerator circuit comprises a plurality of ALUs, and wherein each one of the ALUs is to perform the operation using the input value and a respective one of the plurality of weight parameters.

In Example 9, the subject matter of Example 1 can further provide that the processor is to issue an instruction to the controller, wherein the instruction comprises a total number of bits in the bit stream, and one of the first value or the second value of the control signal.

In Example 10, the subject matter of Example 1 can further provide that a number of bits in the bit stream are fewer than eight bits.

Example 11 is a system-on-a-chip (SoC) comprising an accelerator circuit, associated with a processor, to perform an operation, wherein the processor is to execute a neural network application comprising the operation associated with a weight parameter and an input value, the accelerator circuit comprising a weight storage device to store a bit stream encoding the weight parameter, a controller to request a bit from the bit stream, an input data storage to store the input value, and an arithmetic logic unit (ALU) comprising an accumulator circuit to store an accumulation value, and an operator circuit to receive the bit and the input value, receive a control signal from the controller, and responsive to determining that the control signal is set to a first value corresponding to a first operation and that that the bit encodes a first status, increase the accumulation value, stored in the accumulation circuit, by the input value.

In Example 12, the subject matter of Example 11 can further provide that the operator circuit is further to responsive to determining that the control signal is set to the first value and that the bit encodes a second status, maintain the accumulation value stored in the accumulation circuit.

In Example 13, the subject matter of any of Examples 11 and 12 can further provide that the input data storage comprises an input data buffer to store the input value and a shift circuit to shift, by at least one bit position, the input value stored in the input data buffer.

In Example 14, the subject matter of Example 11 can further provide that responsive to determining that the control signal is set to a second value corresponding to a second operation, the operator circuit is to compare the bit from the bit stream with a rightmost bit in the input buffer, responsive to determining that the bit from the bit stream does not match the rightmost bit, maintain the accumulation value stored in the accumulator circuit, and responsive to determining that the bit from the bit stream matches the rightmost bit, increase the accumulation value stored in the accumulation circuit by one.

In Example 15, the subject matter of any of Examples 11 and 12 can further provide that the controller is to request a second bit from the bit stream, wherein the operator circuit is to determine the accumulation value stored in the accumulator circuit based on the second bit and the input value from the input data storage.

In Example 16, the subject matter of Example 11 can further provide that responsive to determining the accumulation value using a last bit in the bit stream, the processor is to retrieve the accumulation value stored in the accumulation circuit.

In Example 17, the subject matter of Example 11 can further provide that the processor is to issue an instruction to the controller, wherein the instruction comprises a total number of bits in the bit stream, and one of the first value or the second value of the control signal.

In Example 18, the subject matter of Example 11 can further provide that a number of bits in the bit stream are fewer than eight bits.

Example 19 is a method comprising receiving a bit from a bit stream encoding a weight parameter associated with an operation in a neural network, receiving an input value associated with the operation, responsive to determining that the bit encodes a first status, increasing an accumulation value, stored in the accumulation circuit, by the input value, and responsive to determining that the bit encodes a second status, maintaining the accumulation value stored in the accumulation circuit.

In Example 20, the subject matter of Example 19 can further include shifting, by one bit position, the input value, receiving a second bit from the bit stream, responsive to determining that the second bit encodes the first status, increasing an accumulation value, stored in the accumulation circuit, by the input value, and responsive to determining that the second bit encodes the second status, maintaining the accumulation value stored in the accumulation circuit.

Example 21 is an apparatus comprising: means for performing the method of any of Examples 19 and 20.

Example 22 is a machine-readable non-transitory medium having stored thereon program code that, when executed, perform operations comprising receiving a bit from a bit stream encoding a weight parameter associated with an operation in a neural network, receiving an input value associated with the operation, responsive to determining that the bit encodes a first status, increasing an accumulation value, stored in the accumulation circuit, by the input value, and responsive to determining that the bit encodes a second status, maintaining the accumulation value stored in the accumulation circuit.

In Example 23, the subject matter of Example 22 can further provide that the operations further comprises shifting, by one bit position, the input value, receiving a second bit from the bit stream, responsive to determining that the second bit encodes the first status, increasing an accumulation value, stored in the accumulation circuit, by the input value, and responsive to determining that the second bit encodes the second status, maintaining the accumulation value stored in the accumulation circuit.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. A processing system, comprising:
a processor to execute an application comprising an operation associated with a weight parameter and an input value; and
an accelerator circuit, associated with the processor, to perform the operation, the accelerator circuit comprising:
a weight storage device to store a bit stream encoding the weight parameter;
a controller to request a bit from the bit stream;
an input data storage to store the input value; and
an arithmetic logic unit (ALU) comprising:
an accumulator circuit to store an accumulation value; and
an operator circuit to:
receive the bit and the input value;
receive a control signal from the controller; and
responsive to determining that the control signal is set to a first value corresponding to a first operation and that the bit encodes a first status, increase the accumulation value, stored in the accumulation circuit, by the input value.

2. The processing system of claim 1, wherein the operator circuit is further to:
responsive to determining that the control signal is set to the first value and that the bit encodes a second status, maintain the accumulation value stored in the accumulation circuit.

3. The processing system of claim 2, wherein the input data storage comprises:
an input data buffer to store the input value; and
a shift circuit to shift, by at least one bit position, the input value stored in the input data buffer.

4. The processing system of claim 1, wherein responsive to determining that the control signal is set to a second value corresponding to a second operation, the operator circuit is to:
compare the bit from the bit stream with a rightmost bit in the input data buffer;
responsive to determining that the bit from the bit stream does not match the rightmost bit, maintain the accumulation value stored in the accumulator circuit; and
responsive to determining that the bit from the bit stream matches the rightmost bit, increase the accumulation value stored in the accumulation circuit by one.

5. The processing system of claim 2, wherein the controller is to request a second bit from the bit stream, wherein the operator circuit is to determine the accumulation value stored in the accumulator circuit based on the second bit and the input value from the input data storage.

6. The processing system of claim 2, wherein responsive to determining the accumulation value using a last bit in the bit stream, the processor is to retrieve the accumulation value stored in the accumulation circuit.

7. The processing system of claim 1, wherein the application comprises a plurality of nodes, wherein each node is to represent a calculation using the input value and a corresponding weight parameter.

8. The processing system of claim 7, wherein the accelerator circuit comprises a plurality of ALUs, and wherein each one of the ALUs is to perform the operation using the input value and the corresponding weight parameter.

9. The processing system of claim 1, wherein the processor is to issue an instruction to the controller, wherein the instruction comprises a total number of bits in the bit stream, and one of the first value or a second value of the control signal.

10. The processing system of claim 1, wherein a number of bits in the bit stream is fewer than eight bits.

11. A system comprising:
an accelerator circuit, associated with a processor, to perform an operation, wherein the processor is to execute an application comprising the operation associated with a weight parameter and an input value, the accelerator circuit comprising:
a weight storage device to store a bit stream encoding the weight parameter;
a controller to request a bit from the bit stream;
an input data storage to store the input value; and
an arithmetic logic unit (ALU) comprising:
an accumulator circuit to store an accumulation value; and
an operator circuit to:
receive the bit and the input value;
receive a control signal from the controller; and
responsive to determining that the control signal is set to a first value corresponding to a first operation and that the bit encodes a first status, increase the accumulation value, stored in the accumulation circuit, by the input value.

12. The system of claim 11, wherein the operator circuit is further to:
responsive to determining that the control signal is set to the first value and that the bit encodes a second status, maintain the accumulation value stored in the accumulation circuit.

13. The system of claim 12, wherein the input data storage comprises:
an input data buffer to store the input value; and
a shift circuit to shift, by at least one bit position, the input value stored in the input data buffer.

14. The system of claim 11, wherein responsive to determining that the control signal is set to a second value corresponding to a second operation, the operator circuit is to:
compare the bit from the bit stream with a rightmost bit in the input data buffer;
responsive to determining that the bit from the bit stream does not match the rightmost bit, maintain the accumulation value stored in the accumulator circuit; and
responsive to determining that the bit from the bit stream matches the rightmost bit, increase the accumulation value stored in the accumulation circuit by one.

15. The system of claim 14, wherein the controller is to request a second bit from the bit stream, wherein the operator circuit is to determine the accumulation value stored in the accumulator circuit based on the second bit and the input value from the input data storage.

16. The system of claim 11, wherein responsive to determining the accumulation value using a last bit in the bit stream, the processor is to retrieve the accumulation value stored in the accumulation circuit.

17. The system of claim 11, wherein the processor is to issue an instruction to the controller, wherein the instruction comprises a total number of bits in the bit stream, and one of the first value or a second value of the control signal.

18. The system of claim 11, wherein a number of bits in the bit stream is fewer than eight bits.

19. A method comprising:
receiving a bit from a bit stream encoding a weight parameter associated with an operation in a neural network;
receiving an input value associated with the operation;
responsive to determining that the bit encodes a first status, increasing an accumulation value, stored in an accumulation circuit, by the input value; and
responsive to determining that the bit encodes a second status, maintaining the accumulation value stored in the accumulation circuit.

20. The method of claim 19, further comprising:
shifting, by one bit position, the input value;
receiving a second bit from the bit stream;
responsive to determining that the second bit encodes the first status, increasing an accumulation value, stored in the accumulation circuit, by the input value; and
responsive to determining that the second bit encodes the second status, maintaining the accumulation value stored in the accumulation circuit.
